(19) United States
(12) Patent Application Publication
(10) Pub. No.: US 2007/0009639 A1
(43) Pub. Date: Jan. 11, 2007

(54) BARRIER FOR FOOD PARTICLES

(76) Inventors: Robert L. Schuppan, Olathe, KS (US); James L. Thomasson, Gardener, KS (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/426,851

(22) Filed: Jun. 27, 2006

Related U.S. Application Data
(60) Provisional application No. 60/695,583, filed on Jun. 30, 2005.

(51) Int. Cl. A21D 10/00

(52) U.S. Cl. 426/549

(57) ABSTRACT

The invention described herein includes a particle comprising: a bioactive component and a barrier component, the barrier component preventing deterioration of the bioactive component.

Embodiments of the invention described herein relate to food particles that include a barrier and to methods for making and using the food particles with a barrier.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2005, Cereal Ingredients, Inc. All Rights Reserved.

### BACKGROUND

Manufacturers of sugar-coated bakery products have long had to deal with a major problem of moisture migration of either lipids or water from an interior of the products to the surface of the products. This migration creates unsightly “stains” on any surface coating of a sugar or streusel topping, reducing eye appeal of the product and thus its effective shelf life. This situation is made even more serious in hot or moist retail environments.

### DESCRIPTION OF DRAWINGS

FIG. 1 illustrates a structural formula for a sodium salt of alginic acid used in product and process embodiments described herein.

### DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Embodiments of the invention described herein relate to food particles that include a barrier and to methods for making and using the food particles with a barrier. Specifically in the bakery embodiments described herein, the barrier provided can reduce lipid and moisture migration sufficiently to provide up to a week of added shelf life.

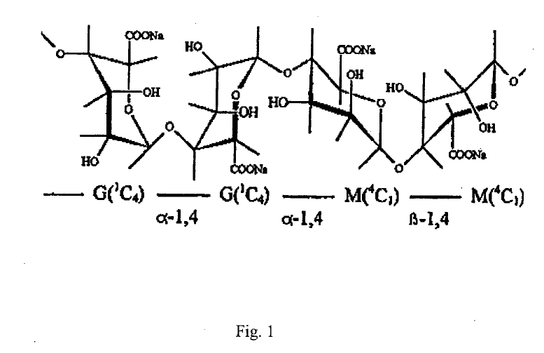

One exemplary embodiment of the invention described herein includes a method for stabilizing food particles in the presence of moisture, lipids, colors, and flavors by enclosing the food particles in a barrier that includes a sodium salt of alginic acid, hereinafter referred to as “AA sodium salt.”. This AA sodium salt has a structural formula as is shown in FIG. 1. The AA sodium salt has a chemical formula of (C(6)H(7)NaO(6))(n). The AA sodium salt has a C.A. S. number of 9005-38-3. The macromolecular weight ranges form 10,000 to 600,000.

In one embodiment, the barrier is prepared by mixing AA sodium salt powder with granular sugar to form a mixture. Water is then added to the barrier mixture to hydrate the AA sodium salt. Food particles are then added to the barrier mixture and are uniformly blended into the mixture. A multivalent cation, such as Ca⁺⁺ in a concentration of less than about 0.01 to 2.0% is added to the blend of food particles and barrier mixture. In one embodiment, a formulation having about 0.0008 percent of multivalent was added. As the blend contacts the multivalent cations, the AA sodium salt crosslinks and forms a gel. The amount and source of the Calcium ion effects the gelling speed and the gelling strength of the sodium salt of the alginic acid. While Calcium (2+) is described, it is believed that other divalent cations such as Ca⁺⁺, Mg⁺⁺, Ba⁺⁺ and Sr⁺⁺, are also usable.

The gelled blend is transferred to an extruder where it is formed and cut to form particulates that include food particles and the alginic acid sodium salt barrier that encloses the food particles. The food particles enclosed within the barrier are protected from reaction with fats, oils, and water. This protection occurs for whole particles, particles that have been ground to a partial powder, and particles that have been ground to a powder. Particles that are enclosed by the barrier have an appearance to a consumer that is indistinguishable from particles that do not include the barrier.

Barrier embodiments have use in foods such as doughnuts, candies, snacks, cereals, ice cream, cake, yogurt, and so forth, as well as pharmaceuticals, cosmetics and skin care products. In one cereal embodiment, a flavorant or colorant or both are capsulated by the barrier and are prevented from migrating. The barrier is particularly useful in stabilizing moisture migration for foods such as cereal particles. The cereal particles include raisin bran, that include a grain based fraction and a dried fruit or vegetable fraction. Migration of moisture from raisins to bran flakes has been a common problem with raisin bran cereal, resulting in hard raisins and mushy flakes. One prior art solution has been to coat flakes with a sugar solution. With the barrier embodiments described herein, the barrier generating ingredients are mixed with sugar in order to cover the surface of the sugar particles and, as a result, to prevent moisture migration.

In another embodiment, a maltodextrin is used instead of sugar. The maltodextrin is also formulated with the barrier in order to cover the surface area of the maltodextrin and to substantially reduce moisture migration.

In another embodiment, grain-based particles are enclosed by the barrier and are added to a water or fat-containing matrix such as yogurt or ice-cream. In a yogurt embodiment, the barrier is usable to suspend particles such as granola particles in a yogurt matrix. In particular, the granola particles are enclosed by the barrier system so that no surface of the granola particles in exposed to the yogurt or ice cream. Presently, granola pieces are separately packaged from the yogurt so that the particles do not become soggy during storage. Barrier embodiments described herein delay moisture from the yogurt from reacting with the granola pieces. For some embodiments, granola pieces may be suspended in yogurt, including flavored yogurt, for two months.

In another embodiment, the particles enclosed in the barrier included particles of a doughnut crunch. Doughnut crunch particles were applied to a doughnut surface. In one embodiment, the doughnut crunch had the following ingredients with the following weight percent:

| Doughnut Crunch Formula | Weight Percent |
|---|---|
| Granulated Sugar | 41.44 |
| Vegetable Oil | 3.49 |
| Cereal Grain | 10.61 |
| Wheat Flour | 30.58 |
| Coconut Emulsion | 0.62 |
| Artificial Color | 0.15 |
| Water | 7.49 |
| Toasted Coconut | 5.62 |

To make the donut crunch, all ingredients were preblended in a horizontal mixture for about five minutes, except shortening, water and coconut to make a blended mixture. The shortening was melted in a separate vessel. The blended ingredients were transferred to a holding bin positioned above the extruder. The blended ingredients were then transferred to a mixing chamber at an inlet of the extruder at a substantially uniform rate.

Once the uniform rate was achieved, water and melted shortening ingredients were metered into the mixing chamber to make a moistened mixture having the concentrations described above. The moistened mixture was transferred to the mixing chamber and into the extruder. A small additional amount of water was introduced into the extruder.

As the mixture exited the extruder through the die, the mixture was cut into small homogeneous pieces. In one embodiment, the small homogeneous pieces were transferred to a perforated band belt oven. The oven included two chambers that were each independently temperature controlled. The control permitted adjustments in retention time in each chamber. The product was transferred through the chambers by the perforated band. The extruded product was dried at 225 degrees Fahrenheit for 5.3 minutes in chamber 1 and at 275 degrees Fahrenheit for 5.3 minutes in chamber 2 for a moisture percentage of 4% to 7% by weight.

Once dried, the extruded product was cooled for ten minutes on the perforated band. The product was transferred to a roller mill and ground to a desired size. A series of sieves following the roller mill classified the product. Overs were returned to the mill for further grinding. Fines were collected and returned to the initial preblended mixture for a second extrusion. Particles within the desired classification range were sent to a holding bin. Prior to packaging, toasted coconut was metered into the product at a desired rate.

The barrier for product and process embodiments described herein, includes a polymer of the sodium salt of alginic acid. Calcium is the catalyst of the polymerization. For some embodiments, the polymerization is a process that begins immediately and takes up to about 24 hours or more to complete.

While doughnut crunch is described, it is believed that any bioactive food particle may be protected from degradation by water or lipids with the sodium salt of alginic acid. “Bioactive substances” as used herein, refer to any material which has a functional or nutritive activity and which typically exhibits low stability, and/or a reduction or loss of bio-effectiveness when exposed to unfavorable conditions. The unfavorable conditions can include, for example, moisture, elevated temperature, oxygen, and acidic or basic pH. When the bioactive substance is exposed to such conditions, the bioactive substance can, for example, decompose, disassociate, deactivate, and/or lose viability.

The food particles enclosed within the barrier system maintain their integrity when in contact with food substrates that include water or lipids or both. The barrier system prevents deterioration of the enclosed food particles by contact with the water or lipids or both from the food substrates. Food substrates include but are not limited to doughnuts and other farinaceous substrates, cookies, cakes, yogurt, pudding, frosting, gravy, dough, bread, and ice cream. Food particles that can be enclosed by the barrier system include but are not limited to food analogs and bioactive food particles.

In another embodiment, a salt-dusted snack product such as a pretzel is treated with the barrier formulation in order to retain large salt crystals firmly to the pretzel. In particular, the salt crystals are enclosed by the barrier system so that the surfaces of the salt crystals are enclosed. The barrier system prevents migration of water and fat from the pretzel to the salt crystals.

In another embodiment, a candy is treated with the barrier formulation. In particular, the candy includes brightly colored pieces that are “locked onto” larger candy pieces. The barrier formulation acts to lock or strongly adhere the brightly colored pieces onto the larger candy pieces to form a stable locking bridge. The locking bridge is stabilized by a diminished water migration between the colored pieces and the larger candy piece.

One other embodiment includes a pet treat for dogs. The pet treat includes flavored, colored particles that are locked into a dog biscuit. The locking or binding occurs because water migration is minimized by the barrier system. In particular, the flavored, colored particles are substantially enclosed by the barrier system. As a result, the color and flavor of the particles is retained in the particles.

Another embodiment includes an application of a coated, colored sugar mixture to a substrate such as a traditional Mexican Concha bread. The particles of the coated, colored sugar mixture are coated with the barrier system described herein. The barrier system not only prevents migration of water and fat, but it also strongly adheres the colored sugar mixture to the bread. These benefits also work with other bread products.

One other embodiment includes a frosting, treated with the barrier system, that is applied to a substrate such as a fresh sweet bun, i.e. a hot-cross bun. Because of the barrier system treatment, the frosting does not deform onto the packaging of the product during the distribution system, thus reducing eye appeal and the effective shelf life of the product.

In a pharmaceutical embodiment, the barrier system is usable to enclose a cocktail of drugs into a single matrix without having the drugs react with each other during storage, thus extending shelf life and preventing premature chemical reactions. In one particular embodiment, drugs used to treat AIDS, such as efavirenz, lamivudine, and Zidovudine, are formulated into a single pill, using the barrier system described herein. Another drug cocktail includes adalimumab and methotrexate, used to treat Rheumatoid arthritis. While an AIDS drug cocktail and a rheumatoid arthritis drug cocktail are described, this type of cocktail is also usable for separating and enclosing other types of pharmaceutical cocktails. Furthermore, embodiments of the barrier system of the invention are usable to separate and enclose skin care agents in a skin care system, hair care agents in a hair care system and cosmetic agents in a cosmetic system.

Although the foregoing invention has been described in some detail for purposes of clarity of understanding, it will be apparent that certain changes and modifications may be practiced within the scope of the appended claims.

1. A particle comprising:
a bioactive component and a barrier component, the barrier component preventing deterioration of the bioactive component.

2. The particle of claim 1, wherein the barrier component comprises a sodium salt of alginic acid.

3. The particle of claim 1, wherein the bioactive component comprises a donut crunch.

4. The particle of claim 2, wherein the sodium salt of alginic acid is polymerized.

5. The particle of claim 1, wherein the bioactive component comprises one bioactive particle.

6. The particle of claim 1, wherein the bioactive component comprises more than one bioactive particle.

7. The particle of claim 1, further comprising sugar.

8. A food comprising one or more of the particles of claim 1.

9. A pharmaceutical comprising one or more of the particles of claim 1.

10. A cosmetic comprising one or more of the particles of claim 1.

11. A skin care product comprising one or more of the particles of claim 1.

12. A method for protecting a bioactive material from water damage and damage from lipids, comprising:
preparing a blend comprising a sodium salt of alginic acid, sugar and water;
adding the bioactive material to the blend and mixing the bioactive material into the blend to make a mixture;
adding a divalent cation to the mixture in a concentration effective to polymerize the mixture; and
extruding the polymerized mixture.

13. The method of claim 12, further comprising cutting the extruded polymerized mixture.

14. A food comprising a substrate comprising one or more of water and a lipid; and
one or more particles comprising: a bioactive component and a barrier component, the barrier component preventing deterioration of the bioactive component, wherein the one or more particles contact the substrate.

15. The food of claim 14, wherein the substrate comprises a doughnut or pastry.

16. The food of claim 14, wherein the particles comprise doughnut crunch.

17. The food of claim 14, wherein the substrate comprises a leavened product.

18. The food of claim 14 wherein the bioactive component is sugar and the substrate is selected from a group consisting of bread, a farinaceous substrate, an unleavened substrate, a leavened substrate, a frosting or icing, yogurt, ice cream, chilled or frozen dessert, cold cereal, hot cereal, animal food, proteinaceous substrate.

19. (canceled)

20. A skin care system, comprising: particles comprising at least two skin care agents and the barrier system of claim 1.

21. A cosmetic system, comprising: particles comprising at least two cosmetic agents and the barrier system of claim 1.

22. A hair care system, comprising: particles comprising at least two hair care agents and the barrier system of claim 1.

23. An animal food comprising one or more of the particles of claim 1.
